(19) United States
(12) Patent Application Publication
(10) Pub. No.: US 2013/0030825 A1
(43) Pub. Date: Jan. 31, 2013

(54) SYSTEMS AND METHODS FOR AUTOMATED TRIAGE AND SCHEDULING IN AN EMERGENCY DEPARTMENT

(71) Applicants: Hanif George Bagwandeen, Washington, DC (US); Alexander Kaber Carroll, Bainbridge Island, WA (US)

(72) Inventors: Hanif George Bagwandeen, Washington, DC (US); Alexander Kaber Carroll, Bainbridge Island, WA (US)

(73) Assignee: General Electric Company, Schenectady, NY (US)

(21) Appl. No.: 13/194,495

(22) Filed: Jul. 29, 2011

(51) Int. Cl. G06Q 50/00; G06Q 10/00

(52) U.S. Cl. 705/2

(57) ABSTRACT

Systems and methods for automated triage and scheduling in an emergency department are described. An example computer-implemented method of automatically triaging and scheduling patients in an emergency department includes associating a patient with an identification bracelet and processing the patient using a patient evaluation device. The processing includes obtaining patient data with the patient evaluation device and dynamically determining a risk level associated with the patient based on the patient data obtained. The method also includes automatically prioritizing and scheduling the patient with a healthcare practitioner based on the risk level determined.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

If a medical emergency occurs (e.g. a car accident, heart attack, stroke, broken bone, etc.), quick action can be important to save lives and reduce permanent injury. If an ill or injured person and/or others with that person cannot obtain up-to-date care information rapidly, the lack of information can cause problems for effective treatment of the individual and potentially endanger the individual and/or delay treatment.

### BRIEF SUMMARY

Certain examples provide methods, systems, apparatus, and/or articles of manufacture for patient emergency response coordination.

An example computer-implemented method of automatically triaging and scheduling patients in an emergency department includes associating a patient with an identification bracelet and processing the patient using a patient evaluation device. The processing includes obtaining patient data with the patient evaluation device and dynamically determining a risk level associated with the patient based on the patient data obtained. The method also includes automatically prioritizing and scheduling the patient with a healthcare practitioner based on the risk level determined.

An example patient evaluation device for use in an emergency department includes a display to receive data from and display data to a patient. The patient evaluation device includes a patient data collector including a plurality of devices or sensors to identify and collect patient data. The patient data includes at least one of patient identifying information, patient diagnosis information, or a patient medical history. The patient evaluation device also includes a processor to determine a risk level of the patient and to schedule the patient for an appointment with a healthcare practitioner based on the risk level determined.

An example tangible computer-readable storage medium including executable instructions for execution using a processor, wherein the instructions, when executed, provide a system to automatically triage and schedule patients in an emergency department. The system includes an assignor to assign a patient an identification bracelet and a processor to process the patient using a patient evaluation device. The processing comprises obtaining patient data from the patient and determining a risk level associated with the patient based on the patient data obtained. The system includes a scheduler to schedule the patient to see a healthcare practitioner based on the risk level determined and a modifier to modify the schedule based on updated feedback from the identification bracelet.

### BRIEF DESCRIPTION OF SEVERAL VIEWS OF THE DRAWINGS

FIG. 1 illustrates an example automated triage and scheduling system for an emergency department.

FIGS. 2 and 3 show flow diagrams of methods of the example triage and scheduling process.

FIG. 4 depicts an example patient monitoring bracelet that can be used to implement the examples described herein.

FIG. 5 depicts an example patient evaluation device that can be used to implement the examples described herein.

FIG. 6 is a block diagram of an example processor system that can be used to implement systems, apparatus, articles of manufacture, and methods shown in FIGS. 1-5 and described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements is hereby expressly defined to include a tangible medium such as a memory, a digital video disc (DVD), compact disc (CD), etc. storing the software and/or firmware.

Emergency Departments (ED) may have limited resources resulting in long patient wait times. While patients are waiting to receive care at an ED, current solutions fail to monitor patients' vital signs and/or receive and/or update information in a triage process with such patient information. Also, while patients are waiting to receive care at an ED, current solutions fail to monitor the patients' whereabouts within the ED, which allows, at least some patients, to leave the ED prior to receiving adequate care.

The examples described herein relate to systems and methods for automatically and continuously identifying risk levels of patients at an ED to increase patient safety. The examples described herein may also dynamically triage and/or schedule patients based on the risk level identified. Using the examples described herein, the number of deaths in EDs associated with failing to immediately treat patients having life-threatening conditions may be reduced. Using the examples described herein, the number of patients leaving the ED prior to evaluation, triaging or otherwise may be reduced. Using the examples described herein, workflows of EDs may be made more efficient by automatically triaging, prioritizing and/or scheduling tasks for high risk patients (e.g., patient's having issues associated with respiratory, facial, neck, chest, cardiovascular, etc.).

To triage, schedule and/or monitor patients within an ED, the examples described herein may automatically collect patient data using a patient evaluation device and monitor patient's vitals, symptoms and/or their whereabouts using a monitoring wristband, for example. The patient evaluation device may include a plurality of devices and/or sensors such as, a video camera, a blood pressure sensor(s), a galvanic skin response sensor(s), a monitor (e.g., touch screen), an infrared camera, a pulse oximetry sensor(s), a data entry device(s) (e.g., a keyboard, a video display or monitor, a mouse, a microphone), etc., to collect patient data prior to, for example, a patient being evaluated by a healthcare practitioner.

Based on the data collected and/or an analysis thereof (e.g., analysis of a chemical(s) from the patient's skin), the patient evaluation device may determine a risk level for the patient, prioritize the patient based on the risk level and/or other patient(s) risk level(s) at the ED and automatically schedule the patient accordingly. If the patient evaluation device determines that the patient is at high risk, a notice or alert may be conveyed to hospital personnel to substantially ensure that the patient receives appropriate care. The patient evaluation device may also issue and/or update the wristband to include at least some of the data collected. The data collected may be saved at a data store associated with a healthcare information system. More specifically, the data collected may be saved to a patient medical record and/or history, etc. At least some of the data collected and/or determinations made by the patient evaluation device may be verified, updated and/or changed by hospital personnel and/or the patient.

The wristband may obtain data (e.g., continuously obtain patient data) from the patient and/or communicate (e.g., receive data, convey data) with the triaging system. To enable such monitoring and/or communication, the wristband may include a Global Positioning System (GPS), a Radio Frequency Identifier (RFID), a display, sensor(s), transceiver(s), transmitter(s), receiver(s), etc. The wristband may monitor the patient's vital signs, the patient's movements within the ED, the patient's location within the ED, etc., and convey the same to the example triaging system which, in turn, may alert ED personnel accordingly. If the wristband and/or sensor's within the ED or healthcare facility detect that an individual possibly in need of care is leaving the ED, the individual's whereabouts and/or a notice that the individual is leaving the ED may be conveyed to the triaging system and/or ED personnel. If the wristband identifies that the patient's risk level is worsening (e.g., changing from a minor threat to life-threating, change in pulse rate, etc.), the triaging system may dynamically change a time at which the patient is to see the doctor/specialist based on the information received and/or request hospital personnel assistance to check the patient's status. For example, if the data obtained from the wristband indicates that the patient's risk level changed to life-threatening from a minor threat, the triaging system will change the order in which the patient is seen by a doctor/specialist (e.g., patient priority level) such that the patient is seen substantially immediately (e.g., such that the patient is prioritized in a clinical workflow, given other priority patients, system delay, etc.). In some examples, the wristband may display information to the patient such as their vital signs, an approximate wait time, etc.

The examples described herein may also enable setting of the example triaging and scheduling system to be customized to, for example, ensure that patients in the most need of immediate care receive substantially immediate treatment. For example, the risk levels and/or priority levels may be customized based on different patient symptoms, etc. The example systems described herein may be integrable with existing scheduling system.

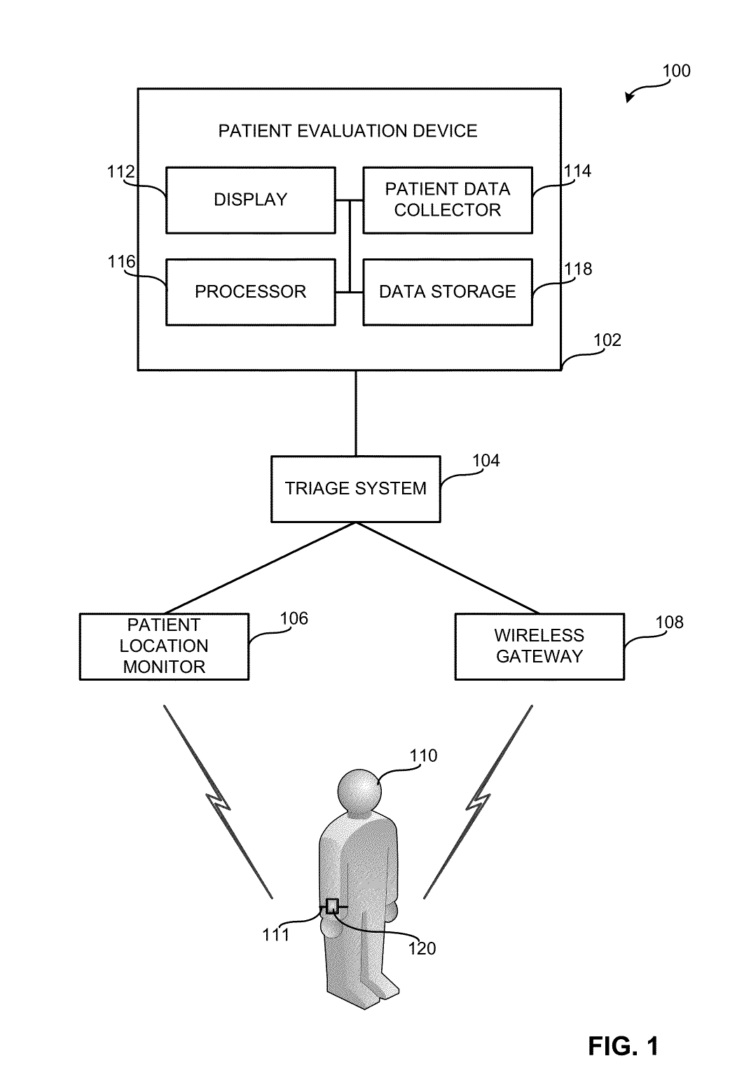

FIG. 1 depicts an example triaging and scheduling system 100 that includes a patient evaluation device 102, a triage system 104, a patient location monitor 106, a wireless gateway 108 and a patient 110 having a wristband 111. In some examples, the patient evaluation device 102, the triage system 104, the patient location monitor 106 and/or the wireless gateway 108 can be implemented in a single system. In some examples, the patient evaluation device 102, the triage system 104, the patient location monitor 106 and/or the wireless gateway 108 can communicate with the patient 110 via the wristband 111. In some examples, the patient 110 and/or data associated therewith can be communicated, via the wristband 111, to the patient evaluation device 102, the triage system 104, the patient location monitor 106 and/or the wireless gateway 108. The wireless gateway 108 may be implemented by, for example, a wireless local and/or Wide area Network, a cellular network and/or any other suitable network/router to route data and/or communications between the patient evaluation device 102, the triage system 104, the wristband 111, etc.

The patient evaluation device 102 may be used to collect data from a patient to facilitate triaging, prioritizing and/or scheduling patients in an ED. The patient evaluation device 102 may analyze the data collected to determine a priority and/or risk level of the patient (e.g., high risk, low risk, etc.). The patient evaluation device 102 may interact with the triage system 104 and/or other systems to schedule patients based on the priority and/or risk level determined. The patient evaluation device 102 may alert healthcare personnel if the priority and/or risk level is above or at a particular level (e.g., high risk).

The patient evaluation device 102 may include a display 112, a patient data collector 114, a processor 116 and a data storage 118. The display 112 may display data and/or receive input from the patient 110. The patient data collector 114 may include a plurality of devices and/or sensors to identify symptoms, vital signs, etc., of the patient 110. The patient data collector 114 may include different devices and/or sensors such as a video camera, a digital camera, a blood pressure sensor(s), a galvanic skin response sensor(s), an infrared camera, a pulse oximetry sensor(s), a data entry device(s), etc.

The processor 116 may drive components of the patient evaluation device 102 and/or cause the patient evaluation device 102 to communicate with the triage system 104, for example. The processor 116 may prompt the patient 110, using the display 112 or otherwise, to enter patient data into the display 112 and/or the patient data collector 114. The patient data may include identifying information (e.g., name, social security number, age, weight, etc.), patient symptoms (e.g., respiratory, facial, neck, chest, cardiovascular), etc. The processor 116 may prompt the patient 110, using the display 112 or otherwise, to scan a previously provided wristband to enable the patient 110 to be identified. The scanner may be associated with the patient data collector 114. Based on the identity of the patient 110, the processor 116 may request, retrieve and/or analyze medical data (e.g., medical record, medical history) associated with the patient 110 to identify associated medical issues. The processor 116 may prompt the patient 110, using the display 112 or otherwise, to interact with the patient data collector 114 to enable patient data to be collected. For example, the patient 110 may be prompted to have their picture taken, their blood pressure taken, their pulse rate taken, skin analyzed, etc.

Based on the data collected, the processor 116 may compare the collected data to the patient's medical history to identify any relevant data, concerns, etc. Based on the data collected and/or the medical history, the processor 116 may determine a priority and/or risk level and/or a preliminary diagnosis for the patient 110. The processor 116 may interact with the triage system 104 to schedule the patient 110 to see a doctor/specialist based on the priority and/or risk level determined. If the priority and/or risk level is at or above a predetermined level, the processor 116 may notify ED personnel that the patient 110 is to see a doctor/specialist substantially immediately.

At least some of the data collected from the patient using the display 112 and/or the patient data collector 114 may be added to the wristband 111 by the patient evaluation device 102. The wristband 111 may be previously issued to the patient 110 or issued and/or generated by the patient evaluation device 102. At least some of the data collected from the patient 110 using the display and/or the patient data collector 114 may be stored at the data storage 118 to a patient medical record, history, etc. The data storage 118 can include any variety of internal and/or external memory, disk, remote storage communicating with the patient evaluation device 102, the triage system 104, etc.

The triage system 104, the patient location monitor 106, the wireless gateway 108 and/or the wristband 111 may interact to increase the safety of the patient 110. For example, the triaging system 104 may schedule patients to see doctors/specialists based on a priority and/or risk level. The patient location monitor 106 may monitor the location of the patient 110 by interacting with the wristband 111 (e.g., Global Positioning System (GPS), Radio Frequency Identifier (RFID), etc.) and/or other sensors within the ED to identify the movement and/or location of the patient 110. The other sensors within the ED may be doorway detectors that alert the triage system 104 and/or hospital personnel if a patient in need of care is attempting to leave the ED. If the patient location monitor 106 determines that the patient 110 is leaving the ED without receiving proper care, the patient location monitor 106 may send an alert to the triaging system 104 and/or hospital personnel accordingly. The wireless gateway 108 may enable communication between the triaging system 104 and the wristband 111.

The wristband 111 may monitor and/or provide information to the patient 110. For example, the wristband 111 may include sensors that monitor vital signs of the patient 110, which may be conveyed, via the wireless gateway 108, to the triaging system 104. Because the patient's state and/or location is being continuously monitored and dynamically fed back into the triage system 104 (e.g., via the wristband 111, the patient location monitor 106 and/or the wireless gateway 108), patients at high risk may receive care in an appropriate manner. For example, if the triage system 104 receives data that the patient's condition is worsening, the priority level and/or time at which the patient 110 is to see the doctor/specialist may change. The wristband 111 may include a display 120 to provide information to the patient 110.

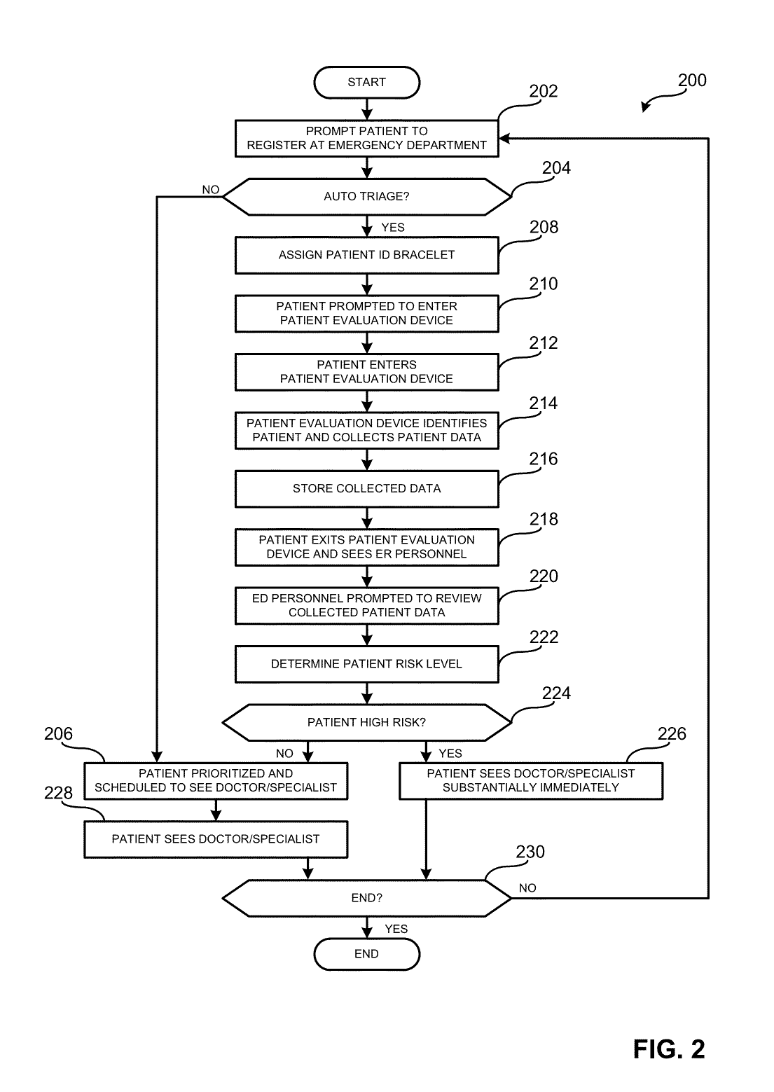

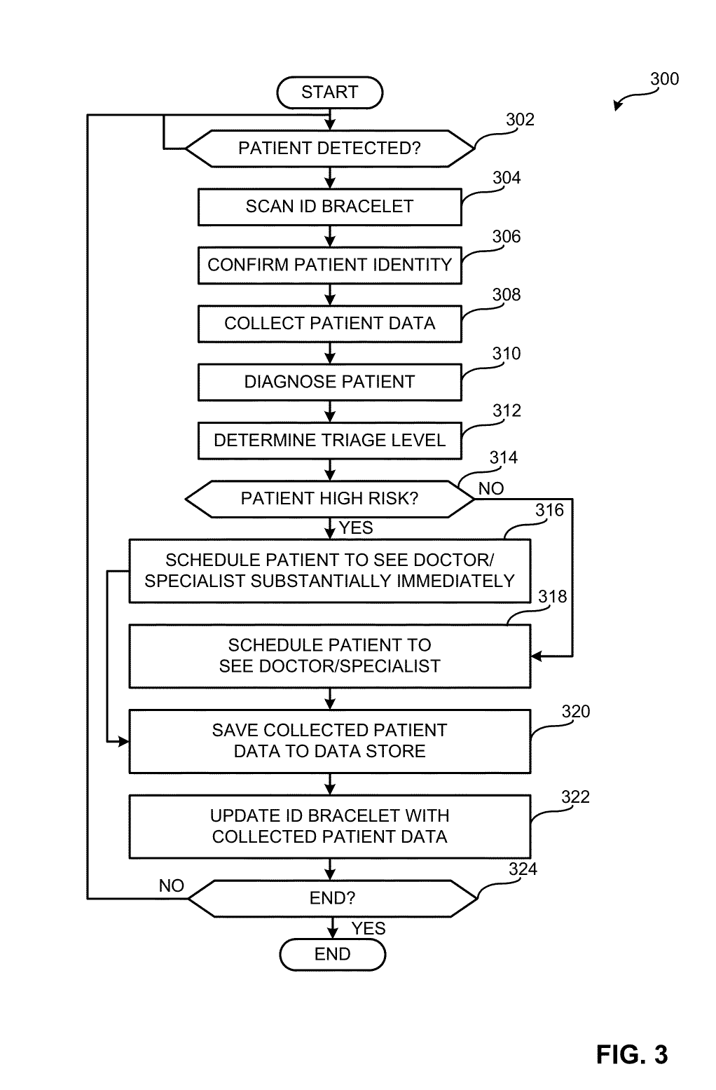

FIGS. 2 and 3 depict example flow diagrams representative of processes that may be implemented using, for example, computer readable instructions that may be used to automatically triage and schedule patients in an Emergency Department (ED). The example processes of FIGS. 2 and 3 may be performed using a processor, a controller and/or any other suitable processing device. For example, the example processes of FIGS. 2 and 3 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 2 and 3 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 2 and 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 2 and 3 may be implemented manually or as any combination(s) of any of the foregoing techniques, for example, any combination of firmware, software, discrete logic and/or hardware. Further, although the example processes of FIGS. 2 and 3 are described with reference to the flow diagrams of FIGS. 2 and 3, other methods of implementing the processes of FIGS. 2 and 3 may be employed. For example, the order of execution of the blocks may be changed, and/or some of the blocks described may be changed, eliminated, sub-divided, or combined. Additionally, any or all of the example processes of FIGS. 2 and 3 may be performed sequentially and/or in parallel by, for example, separate processing threads, processors, devices, discrete logic, circuits, etc.

FIG. 2 shows a flow diagram for an example method 200 of triaging and scheduling patients. The example triaging and scheduling process illustrates how the examples described herein may be used to reduce the number of deaths in EDs associated with failing to immediately treat patients having life-threatening conditions and/or to reduce the number of patients leaving the ED prior to evaluation, triaging or otherwise. Additionally, the example method 200 describes how the examples described herein may make workflows of EDs more efficient by automatically triaging, prioritizing and/or scheduling tasks for high risk patients (e.g., patient's having issues associated with respiratory, facial, neck, chest, cardiovascular, etc.).

At block 202, the method 200 prompts a patient to register at an emergency department. The patient may be prompted by hospital personnel, signs or indicators, etc. At block 204, the method 200 determines if the patient is to be auto triaged. The method 200 may determine if the patient is to be auto triaged based on the number of patients waiting to be seen by a doctor/specialist, the patient's medical condition, etc. If the method 200 determines that the patient is not to be auto triaged, control moves to block 206 where the patient is prioritized and/or scheduled to see the doctor/specialist. Alternatively, control may advance to block 226, discussed below.

However, if the method 200 determines that the patient is to be auto triaged, control moves to block 208 where the patient is assigned an ID bracelet. The ID bracelet may be assigned to the patient by a healthcare practitioner, a patient evaluation device, etc. The ID bracelet may include sensors and/or a display to enable communication with the patient, monitoring of the patient, etc.

At block 210, the patient may be prompted to enter a patient evaluation device by, for example, healthcare personnel, signs, indicators, etc. The patient evaluation device may be a booth or other structures having devices and/or sensors to obtain and/or analyze patient data. At block 212, the patient enters the patient evaluation device.

At block 214, the patient evaluation device may identify the patient and collect data from the patient. The patient evaluation device may identify the patient by scanning the ID bracelet, having the patient enter identifying information into the patient evaluation device, etc. The patient evaluation device may collect data from the patient by performing a plurality of tests and/or take a plurality of readings from the patient. For example, the patient evaluation device may determine the patient's blood pressure, video tape their behavior to identify abnormalities, determine the patient's pulse rate, take an identification photo of the patient, etc. The patient evaluation device may diagnosis the patient based on the data collected. The patient evaluation device may determine a risk and/or priority level based on the data collected.

At block 216, the data collected using the patient evaluation device may be stored at a data store and, at block 218, the patient exits the patient evaluation device to see ED personnel. At block 220, the ED personnel may be prompted to review the collected data, the diagnosis made, the priority and/or risk level assigned by the patient evaluation device. In some examples, the ED personnel may modify, update, change the data collected, the diagnosis made and/or the priority and/or risk level assigned by the patient evaluation device based on, for example, patient feedback.

At block 222, the method 200 may determine the patient risk level. The patient risk level may be determined by the patient evaluation device, ED personnel, etc. At block 224, the method 200 determines if the patient has a high risk level. If the patient has a high risk level, control moves to block 226 and the method 200 schedules the patient to see a doctor/specialist substantially immediately and the patient then sees the doctor/specialist. At block 226, the method 200 may also alert ED personnel that the patient is a high risk patient. However, if the method 200 determines that the patient is not a high risk patient, control moves to block 206 and the patient is prioritized and scheduled based on the priority and/or risk level assigned and, at block 228, the patient sees the doctor/specialist. For example, patients having a moderate risk level may be scheduled to see a doctor/specialist prior to patients having a lower risk level. At block 230, the method 200 determines whether to return to block 202. Otherwise, the example method 200 is ended.

FIG. 3 shows a flow diagram for an example method 300 of triaging and scheduling patients. The example triaging and scheduling process illustrates how the examples described herein may be used to automatically collect patient data, determine patient priority and/or risk levels and provide appropriate care to the patients accordingly.

At block 302, the method 300 determines if a patient has been detected within, for example, the patient evaluation device. At block 304, the method 300 scans an ID bracelet associated with the patient. The patient evaluation device may prompt the patient to scan the ID bracelet using, for example, a video display, audio instructions, etc. The ID bracelet may include patient identifying information and/or other medical data stored thereon and/or associated therewith. At block 306, the method 300 confirms the identity of the patient. For example, the method 300 may display patient data associated with the ID bracelet on a monitor and request that the patient confirms its accuracy. Additionally or alternatively, the patient evaluation device may be expecting to evaluate a particular patient and, thus, the method 300 may verify that the identity associated with the ID bracelet is the same as the expected identity of the patient to be evaluated.

At block 308, the method 300 may collect patient data. The patient data collected may include symptoms, a patient medical history, medications that the patient is taking, medications that the patient is allergic to, the patient's temperature, the patient's blood pressure, the patient's heart rate, the patient's photo, the patient's behavior, etc. At blocks 310 and 312, the method 300 may diagnose and/or determine a triage level for the patient. The triage level determined may be based on the collected patient data, the patient's medical history, etc. The diagnosis may be that the patient has a broken bone, the patient is having a stroke, a heart attack, etc.

At block 314, the method 300 determines if the patient is a high risk patient. If the patient is a high risk patient, control moves to block 316 and the patient is scheduled to see a doctor/specialist substantially immediately. However, if the patient is not a high risk patient, control moves to block 318 and the patient is scheduled to see a doctor/specialist based on, for example, the risk level determined.

At block 320, the method 300 saves the collected data and/or the analysis thereof to a data store, and at block 322, the method 300 updates the ID bracelet with at least some of the collected patient data. At block 324, the method 300 determines whether to return to block 302, otherwise the example method 300 is ended.

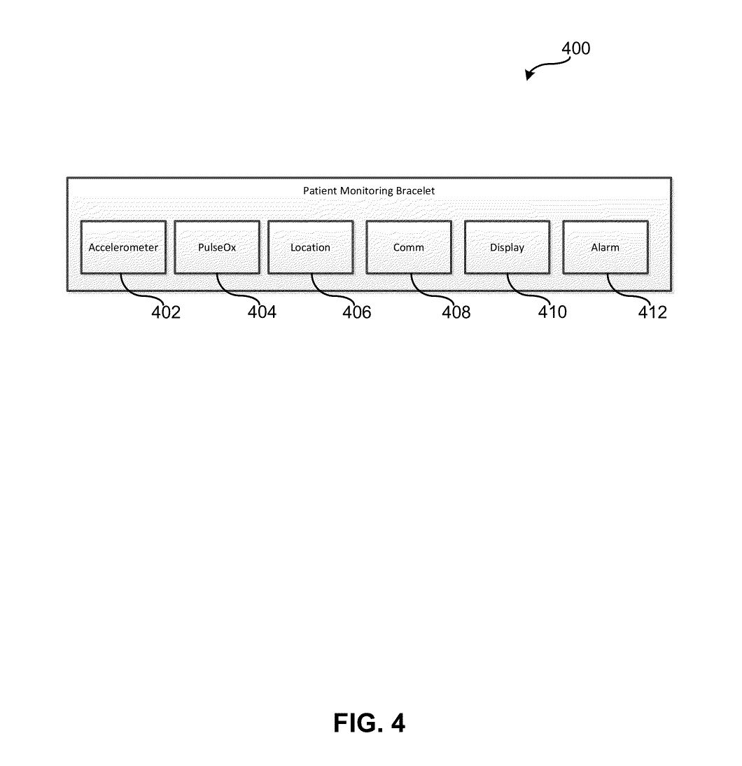

FIG. 4 depicts a schematic illustration of an example patient monitoring bracelet 400 that may be used to implement the examples described herein. The bracelet 400 may include a plurality of sensors and/or devices in communication with a doorway bracelet detector and/or alarm system, a patient location monitor, a wireless gateway and/or ED triaging system. The bracelet 400 may include an accelerometer 402, a pulse oximetry sensor 404, a location sensor 406, a communication device 408, a display 410 and/or an alarm 412. The accelerometer 402 may be used to detect movement of the patient. The pulse oximetry sensor 404 may be used to monitor the oxygenation of the patient's hemoglobin. The location sensor 406 may be used to determine the patient's whereabouts within and/or relative to the ED. The communication device 408 may enable the bracelet 400 to receive and/or convey data to, for example, a doorway bracelet detector and/or alarm system, a patient location monitor, a wireless gateway and/or a ED triaging system, etc. The display 410 may provide information to the patient such as an approximate wait time, when it is time for the patient to be seen by the doctor/specialist, etc. The alarm 412 may alert the patient and/or hospital personnel, etc. of any changes in the patient's risk level or other issues.

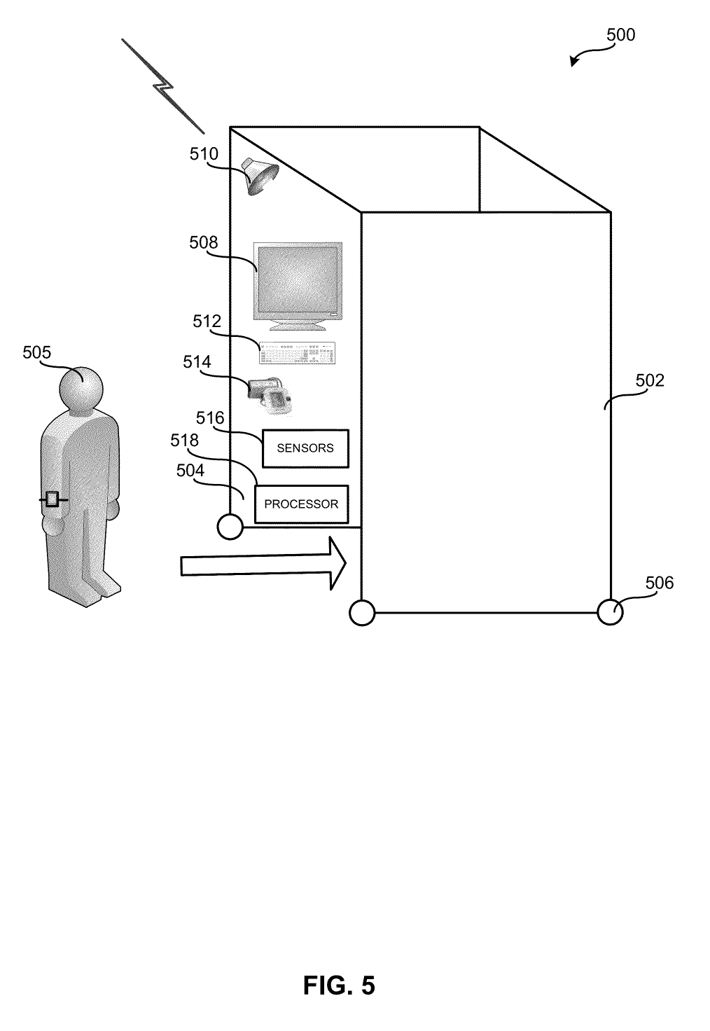

FIG. 5 depicts an example mobile patient evaluation device 500 that may be used to implement the examples described herein. The device 500 includes a plurality of walls 502 and 504 to provide a patient 505 with at least some privacy as they are using and/or being evaluated by the device 500. In some examples, the device 500 may be configured as an archway through which the patient 505 enters when using the device 500. The device 500 may include wheels 506 to enable the device 500 to be easily moved within the ED. However, in other examples, the device 500 may be a permanent structure within the ED. The device 500 may include a monitor 508, a speaker 510, a data entry device (e.g., keyboard) 512, a blood pressure device 514, sensors 516 and/or a processor 518. The sensors 516 may include a video camera, a blood pressure sensor, a galvanic skin response sensor, a monitor, an infrared camera, a pulse oximetry sensor, etc. As discussed above, the device 500 may be communicatively coupled to a triage system and/or a healthcare information system to convey and/or receive information relating to the patient 505.

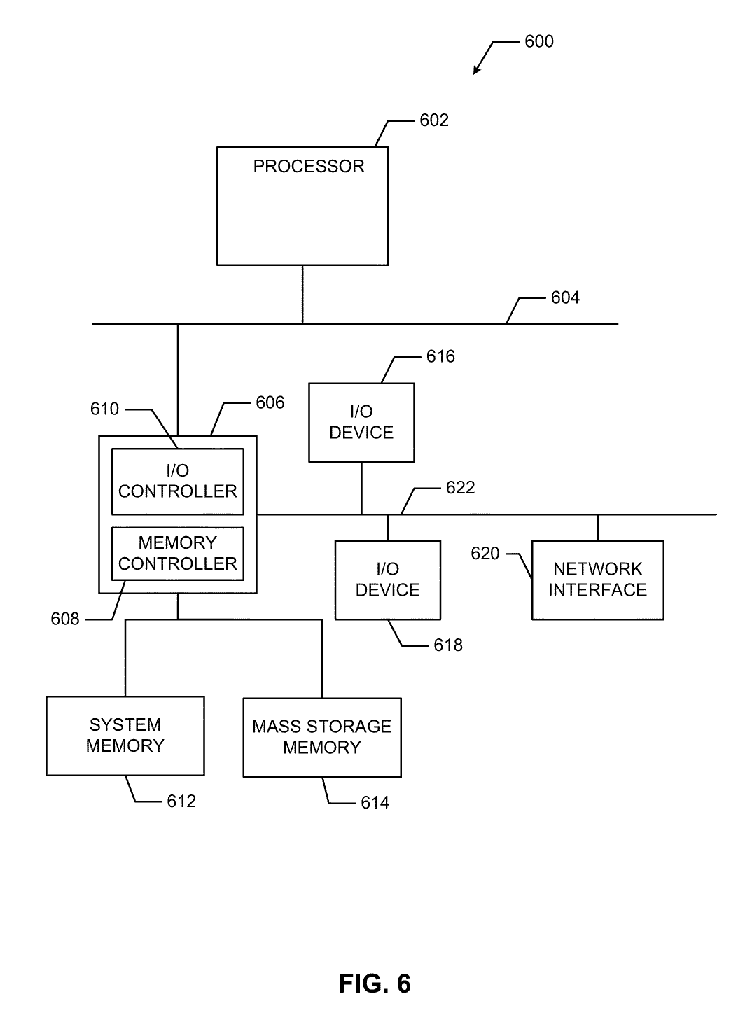

FIG. 6 is a block diagram of an example processor system 600 that may be used to implement the systems and methods described herein. As shown in FIG. 6, the processor system 600 includes a processor 602 that is coupled to an interconnection bus 604. The processor 602 may be any suitable processor, processing unit or microprocessor. Although not shown in FIG. 6, the processor system 600 may be a multi-processor system and, thus, may include one or more additional processors that are identical or similar to the processor 602 and that are communicatively coupled to the interconnection bus 604.

The processor 602 of FIG. 6 is coupled to a chipset 606, which includes a memory controller 608 and an input/output (I/O) controller 610. As is well known, a chipset typically provides I/O and memory management functions as well as a plurality of general purpose and/or special purpose registers, timers, etc. that are accessible or used by one or more processors coupled to the chipset 606. The memory controller 608 performs functions that enable the processor 602 (or processors if there are multiple processors) to access a system memory 612 and a mass storage memory 614.

The system memory 612 may include any desired type of volatile and/or non-volatile memory such as, for example, static random access memory (SRAM), dynamic random access memory (DRAM), flash memory, read-only memory (ROM), etc. The mass storage memory 614 may include any desired type of mass storage device including hard disk drives, optical drives, tape storage devices, etc.

The I/O controller 610 performs functions that enable the processor 602 to communicate with peripheral input/output (I/O) devices 616 and 618 and a network interface 620 via an I/O bus 622. The I/O devices 616 and 618 may be any desired type of I/O device such as, for example, a keyboard, a video display or monitor, a mouse, etc. The network interface 620 may be, for example, an Ethernet device, an asynchronous transfer mode (ATM) device, an 802.11 device, a DSL modem, a cable modem, a cellular modem, etc. that enables the processor system 600 to communicate with another processor system.

While the memory controller 608 and the I/O controller 610 are depicted in FIG. 6 as separate blocks within the chipset 606, the functions performed by these blocks may be integrated within a single semiconductor circuit or may be implemented using two or more separate integrated circuits.

Thus, certain examples provide a tool for patient diagnosis and treatment. Certain examples provide an ability to automate much of the patient triage process, automatically determine a level of risk to assign to the patient, schedule the patient to be seen based on that assignment, and track the patient in the ED.

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a machine accessible or readable medium and executable by, for example, a processor (e.g., the example processor 116 of FIG. 1). When any of the appended claims are read to cover a purely software and/or firmware implementation, at least one of the components is hereby expressly defined to include a tangible medium such as a memory, DVD, CD, etc. storing the software and/or firmware.

FIGS. 1-6 include data and/or process flow diagrams representative of machine readable and executable instructions or processes that can be executed to implement the example systems, apparatus, and article of manufacture described herein. The example processes of FIGS. 1-6 can be performed using a processor, a controller and/or any other suitable processing device. For example, the example processes of FIGS. 1-6 can be implemented in coded instructions stored on a tangible medium such as a flash memory, a read-only memory (ROM) and/or random-access memory (RAM) associated with a processor (e.g., the processor 116 of FIG. 1). Alternatively, some or all of the example processes of FIGS. 1-6 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 1-6 can be implemented manually or as any combination(s) of any of the foregoing techniques, for example, any combination of firmware, software, discrete logic and/or hardware. Further, although the example processes of FIGS. 1, 4 and 5 are described with reference to the flow diagrams of FIGS. 2 and 3, other methods of implementing the processes of FIGS. 1-, 4 and 5 can be employed. For example, the order of execution of the blocks may be changed, and/or some of the blocks described may be changed, eliminated, sub-divided, or combined. Additionally, any or all of the example processes of FIGS. 1-6 can be performed sequentially and/or in parallel by, for example, separate processing threads, processors, devices, discrete logic, circuits, etc.

One or more of the components of the systems and/or blocks of the methods described above may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device. Certain examples may omit one or more of the method blocks and/or perform the blocks in a different order than the order listed. For example, some blocks may not be performed in certain embodiments of the present invention. As a further example, certain blocks may be performed in a different temporal order, including simultaneously, than listed above.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments/examples, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method of automatically triaging and scheduling patients in an emergency department, the method comprising:
associating a patient with an identification bracelet;
processing the patient using a patient evaluation device, wherein the processing comprises obtaining patient data with the patient evaluation device and dynamically determining a risk level associated with the patient based on the patient data obtained; and
automatically prioritizing and scheduling the patient with a healthcare practitioner based on the risk level determined.

2. The method of claim 1, wherein, if the risk level is at or above a predetermined level, the patient is to see the healthcare practitioner substantially immediately.

3. The method of claim 1, wherein obtaining patient data comprises obtaining at least one of patient identifying information, vital signs, symptoms of the patient, or an associated medical record or history.

4. The method of claim 1, further comprising updating the identification bracelet with at least some of the patient data obtained.

5. The method of claim 1, further comprising alerting the healthcare practitioner if the risk level is at or above a predetermined level.

6. The method of claim 1, wherein the patient evaluation device is to further determine a diagnosis of the patient based on at least one of the patient data obtained or an associated medical history.

7. The method of claim 1, further comprising monitoring the patient using the identification bracelet and identifying a change in the risk level associated with the patient.

8. The method of claim 7, further comprising changing when the patient is to see the healthcare practitioner based on identifying a change in the risk level associated with the patient.

9. The method of claim 7, further comprising alerting the healthcare practitioner based on identifying a change in the risk level associated with the patient.

10. The method of claim 1, further comprising monitoring the location or movements of the patient using the identification bracelet or other sensors within the emergency department to substantially ensure the patient does not leave the emergency department prior to receiving appropriate care.

11. The method of claim 1, further comprising providing information to the patient via the identification bracelet.

12. A patient evaluation device for use in an emergency department, comprising:
a display to receive data from and display data to a patient;
a patient data collector comprising a plurality of devices or sensors to identify and collect patient data, the patient data comprises at least one of patient identifying information, patient diagnosis information, or a patient medical history; and
a processor to determine a risk level of the patient and to schedule the patient for an appointment with a healthcare practitioner based on the risk level determined

13. The patient evaluation device of claim 12, wherein the devices or sensors comprise one or more of a video camera, a blood pressure sensor, a galvanic skin response sensor, a monitor, an infrared camera, a pulse oximetry sensor, or a data entry device.

14. The patient evaluation device of claim 12, wherein the processor is to add at least some of the collected patient data to an identification bracelet associated with the patient.

15. The patient evaluation device of claim 12, wherein the processor is configured to alert the healthcare practitioner if the risk level is at or above a predetermined level.

16. The patient evaluation device of claim 12, wherein the patient evaluation device is communicatively coupled to a triaging or scheduling system associated with the emergency department.

17. The patient evaluation device of claim 1, wherein the patient evaluation device comprises a structure that enables the patient to physically interact with at least portions of the patient evaluation device.

18. A tangible computer-readable storage medium including executable instructions for execution using a processor, wherein the instructions, when executed, provide a system to automatically triage and schedule patients in an emergency department, the system comprising:
an assignor to assign a patient an identification bracelet;
a processor to process the patient using a patient evaluation device, wherein the processing comprises obtaining patient data from the patient and determining a risk level associated with the patient based on the patient data obtained;
a scheduler to schedule the patient to see a healthcare practitioner based on the risk level determined; and
a modifier to modify the schedule based on updated feedback from the identification bracelet.

19. The tangible computer-readable storage medium of claim 18, further comprising an updater to update the identification bracelet with at least some of the patient data obtained.

20. The tangible computer-readable storage medium of claim 18, further comprising an alerter to alert the healthcare practitioner if the risk level is at or above a predetermined level.

21. The tangible computer-readable storage medium of claim 18, wherein the processor is to further determine a diagnosis of the patient based on at least one of the patient data obtained or an associated medical history.

22. The tangible computer-readable storage medium of claim 18, wherein the identification bracelet is configured to monitor the patient.
